(19) United States
(12) Patent Application Publication
(10) Pub. No.: US 2008/0062009 A1
(43) Pub. Date: Mar. 13, 2008

(54) Method and system to improve traffic flow

(76) Inventor: Keith J. Marton, Houston, TX (US)

Correspondence Address: GREENBERG TRAURIG (HOU);INTELLECTUAL PROPERTY DEPARTMENT, 1000 Louisiana Street, Suite 1800, Houston, TX, 77002, US

(21) Appl. No.: 11/512,511

(22) Filed: Aug. 30, 2006

(51) Int. Cl. G08G 1/054

(52) U.S. Cl. 340/937

(57) ABSTRACT

Embodiments of the present invention provide for a system to detect and cite tailgating violations. The system may comprise a tailgating detector adapted to detect a tailgating vehicle, a recorder adapted to record identification information specific to the tailgating vehicle, an identification computer in communication a vehicle and registrant identification information database, a citation preparation computer adapted to prepare a tailgating citation, and a communication means for communicating the tailgating citation to the tailgating violator. The system may further include a payment computer adapted to determine whether proper payment has been received for the tailgating citation, a scheduling computer in communication with a court schedule database, a summons preparation computer adapted to prepare a summons, and a communication means for communicating the summons to the tailgating violator. Embodiments of the present invention also provide for a method to detect and cite tailgating violations.

### BACKGROUND OF THE INVENTION

1. Field of the Invention

This invention relates generally to methods and systems to improving traffic flow and, more specifically, to methods and systems to detect and cite tailgating violations.

2. Description of the Related Art

Tailgating, or following a vehicle too closely, is a serious problem on the world's roadways. Tailgating is a function of following distance and speed. When the distance between a lead vehicle and a following vehicle is short, the likelihood of a collision increases because the time available for the driver of the following vehicle to react to the stopping or slowing of the lead vehicle also is short. The likelihood of a collision also increases at high speeds because the vehicles cover more distance per unit time and therefore more distance is necessary for the driver of the following vehicle to react. In addition to being dangerous, tailgating also disrupts traffic flow. A chain reaction can result in response to one vehicle flashing its brake lights wherein each following vehicle does the same. This chain reaction can lead to traffic congestion, excessive travel times, decreased fuel economy, and added air pollution.

Various systems for detecting tailgating have been proposed or used in the past. One system used in Germany includes one or more video cameras that provide a video feed to an operator in a mobile unit. The operator can notify a police officer farther down the road if a tailgating violation is detected. The police officer notified of the violation then issues a citation for the tailgating violation. The German system requires at least two people to operate each enforcement point along a roadway.

U.S. Pat. No. 3,618,003 describes a system and method for determining the time interval between two vehicles. The system employs inductance coil sensors and an array of switches to time the interval between the passage of the rear end of a first vehicle and the arrival of the front end of a second vehicle. A video camera may be activated if the time interval between vehicles is too short for the second vehicle to safely react to the slowing of the first vehicle. U.S. Pat. No. 3,737,851 describes a similar system that employs radiant energy beams to detect vehicles and a minimum timing interval to prevent the erroneous detection of towed vehicles and trailers. U.S. Pat. No. 5,066,950 describes an improved system also using radiation beams. That system uses two radiation beams to detect the separation between vehicles and the speed of the vehicles. The speed information can be used to time a photograph of a vehicle detected as following too closely so that the image captured will be properly centered on the vehicle of interest.

U.S. Pat. No. 5,809,161 discloses a vehicle monitoring system having a vehicle detection camera and an image acquisition camera. The detection camera can determine vehicle speed and discriminate between multiple vehicles in the field of view. The image acquisition camera can photograph vehicles of interest. The system thus permits recognition and recordation of vehicles following too closely to the vehicle ahead. The system may then read the license plate of the vehicle of interest using optical character recognition. The license plate information and photographs may then be sent via a network to a server on a network. U.S. Pat. No. 6,760,061 discloses an apparatus for monitoring traffic that uses video frames divided into tiles for identifying objects and their physical parameters. The apparatus can detect various traffic violations and record the license plate of the offending vehicle.

U.S. Pat. No. 6,188,329 discloses a system for integrating traffic light violation related vehicle data with court date scheduling information. The system uses one or more video cameras to capture images of vehicles engaged in potential traffic light violations. The video data is made available to a user who can determine if a violation in fact occurred. If so, the user extracts vehicle identification information, such as a license plate number, from the recorded video images and enters it into a database maintained by a department of motor vehicles or similar organization. The system then facilitates the creation of a citation by the user that contains violation image data, vehicle and owner information, the citation number, and the amount due. A court date may then be scheduled using the information on the citation in the event that the violator does not pay the amount due.

### SUMMARY OF THE INVENTION

In one embodiment of the present invention, a system to detect and cite tailgating violations is described. The system may comprise a tailgating detector adapted to detect a tailgating vehicle. The tailgating detector may comprise, for example, an inductance coil, a radiant beam, or a video camera. The system further may comprise a recorder such as a digital camera or video camera in communication with the tailgating detector and adapted to record identification information specific to the tailgating vehicle such as a license plate number. The system also may include an identification computer in communication with the recorder and a vehicle and registrant identification information database, the identification computer adapted to identify a tailgating violator by comparing the identification information specific to the tailgating vehicle to the vehicle and registrant identification information contained in the vehicle and registrant identification information database. The system additionally may comprise a citation preparation computer in communication with the identification computer, the citation preparation computer adapted to prepare a tailgating citation. The system further may comprise a citation communication means, such as mail or email, for communicating the tailgating citation to the tailgating violator. The system optionally may include a review workstation adapted to facilitate review of the identity of the tailgating violator or the tailgating citation by a human user such as a police officer. The system also may include a payment computer adapted to determine whether proper payment has been received for the tailgating citation. The system additionally may comprise a scheduling computer in communication with a court schedule database and, for example, the identification computer, payment computer or citation preparation computer, the scheduling computer adapted to identify an available court date. Furthermore, the system may include a summons preparation computer in communication with the scheduling computer, the summons preparation computer adapted to prepare a summons. The system also may include a summons communication means for communicating the summons to the tailgating violator.

In a further embodiment, a method to detect and cite tailgating violations using an automated system is described. The method may comprise the step of detecting a tailgating vehicle with a tailgating detector. The method also may comprise the steps of recording the tailgating vehicle with a recorder and reading identification information specific to the tailgating vehicle. The method preferably also includes the steps of accessing a vehicle and registrant identification information database and comparing the identification information specific to the tailgating vehicle to the vehicle and registrant information contained in the vehicle and registrant identification information database. The method further may include the step of identifying a tailgating violator by correlating the identification information specific to the tailgating vehicle to the registrant of the tailgating vehicle. The method additionally may include the steps of preparing a tailgating citation with a citation preparation computer and communicating the tailgating citation to the tailgating violator. One or more of these steps optionally may be reviewed by a human user. The method also may include the step of determining whether proper payment has been received for the tailgating citation. If proper payment has been received, the process may terminate. If proper payment has not been received, the method may continue to the steps of accessing a court schedule database with a scheduling computer in communication with the court schedule database, identifying an available court date, scheduling a court date on the available court date, preparing a summons with a summons preparation computer, and communicating the summons to the tailgating violator. Alternatively, a court date may be scheduled and a summons prepared and communicated to the tailgating violator approximately concurrently with the preparation of the tailgating citation and communication of the citation to the tailgating violator.

### BRIEF DESCRIPTION OF THE DRAWINGS

Although some of the features and benefits of the present invention having been stated, others will become apparent as the description proceeds when taken in conjunction with the accompanying drawings, in which:

FIG. 1 is an illustration of a tailgating detector and a recorder in communication with the tailgating detector in accordance with an embodiment of the present invention.

FIG. 2 is an illustration of a tailgating detector and a recorder in communication with the tailgating detector in accordance with a further embodiment of the present invention.

FIG. 3 is an illustration of a tailgating detector and a recorder in communication with the tailgating detector in accordance with another embodiment of the present invention.

FIG. 4 is a flowchart of methods for issuing tailgating citations and scheduling court dates according to an embodiment of the present invention.

FIG. 5A is a flowchart illustrating a method to detect and cite tailgating violations in accordance with an embodiment of the present invention.

FIG. 5B is a flowchart illustrating a method to detect and cite tailgating violations in accordance with an embodiment of the present invention.

### DETAILED DESCRIPTION

The present invention now will be described more fully hereinafter with reference to the accompanying drawings in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

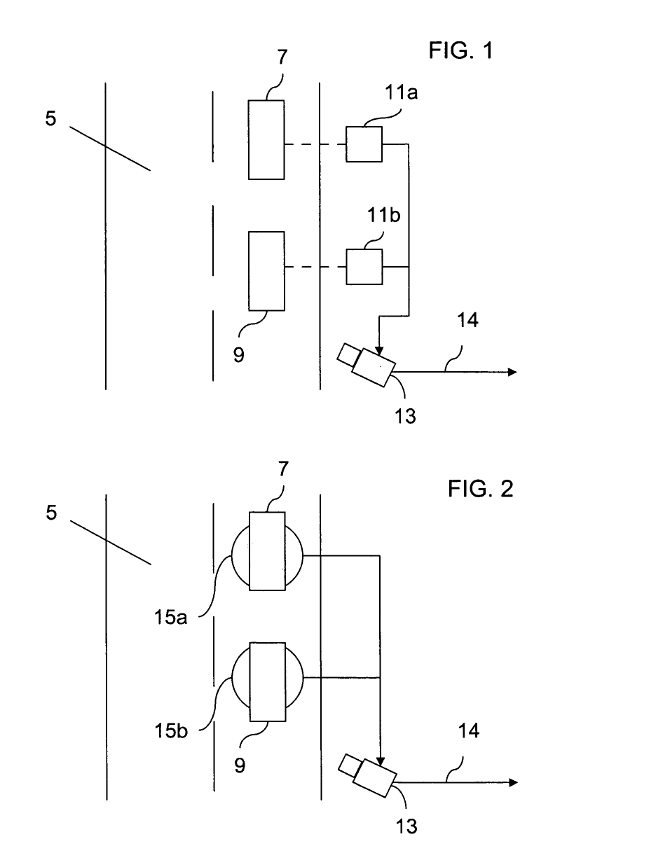

FIG. 1 is an illustration of a tailgating detector and a recorder in communication with the tailgating detector in accordance with an embodiment of the present invention. Roadway 5 includes lead vehicle 7 and following vehicle 9 traveling thereupon. Radiant beam sensors 11a, 11b are positioned at the side of the roadway. Alternately, radiant beam sensors 11a, 11b may be placed above the roadway or in any other position from where they may detect tailgating violations by vehicles traveling upon roadway 5. In the event, for example, where both beams are broken simultaneously by separate vehicles, a signal may be sent to a recorder or camera 13, which camera 13 is in communication with radiant beam sensors 11a, 11b. Camera 13 may be, for example, a digital camera or a video camera. Camera 13 may capture images of following vehicle 9 when signaled by radiant beam sensors 11a, 11b. More specifically, camera 13 may record identification information specific to following vehicle 9, such as a license plate number. The image data may be communicated from camera 13 through communication network 14 such as a cellular phone network, LAN, WiFi, WiMax, satellite network, the Internet, or other appropriate communication network as understood by those of skill in the art. In the illustrated example, following vehicle 9 is a tailgating vehicle because it is following lead vehicle 7 too closely.

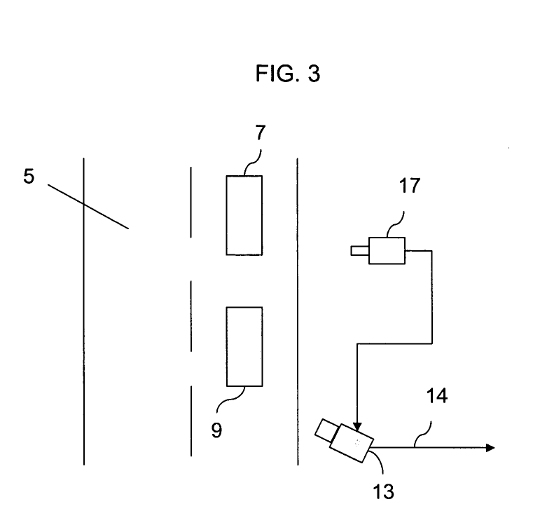

FIG. 2 is an illustration of a tailgating detector and a recorder in communication with the tailgating detector in accordance with an embodiment of the present invention. Roadway 5 includes lead vehicle 7 and following vehicle 9 traveling thereupon. Inductance coil sensors 15a, 15b are positioned below or on the surface of the roadway. In the event, for example, where both inductance coil sensors detect separate vehicles simultaneously, a signal may be sent to a recorder or camera 13, which camera 13 is in communication with inductance coil sensors 15a, 15b. Camera 13 may be, for example, a digital camera or a video camera. Camera 13 may capture images of following vehicle 9 when signaled by inductance coil sensors 15a, 15b. More specifically, camera 13 may record identification information specific to following vehicle 9, such as a license plate number. The image data may be communicated from camera 13 through communication network 14 such as a cellular phone network, LAN, WiFi, WiMax, satellite network, the Internet, or other appropriate communication network as understood by those of skill in the art. In the illustrated example, following vehicle 9 is a tailgating vehicle because it is following lead vehicle 7 too closely.

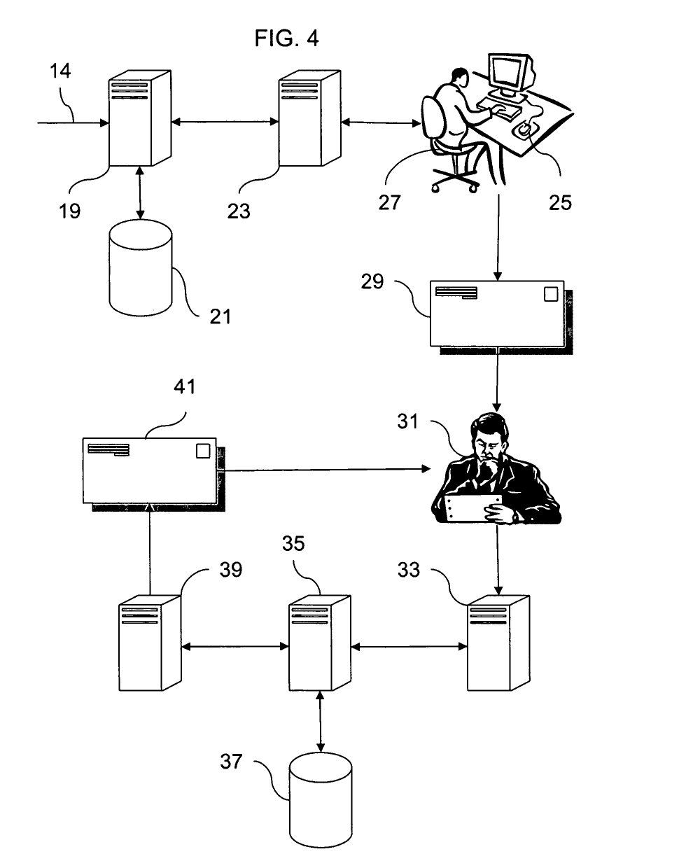

FIG. 3 is an illustration of a tailgating detector and a recorder in communication with the tailgating detector in accordance with an embodiment of the present invention. Roadway 5 includes lead vehicle 7 and following vehicle 9 traveling thereupon. Video camera detector 17 is positioned at the side of the roadway. Alternately, video camera detector 17 may be placed above the roadway or in any other position from where it may detect tailgating violations by vehicles traveling upon roadway 5. In the event, for example, where video camera detector 17 detects two vehicles traveling two closely on roadway 5, a signal may be sent to a recorder or camera 13, which camera 13 is in communication with video camera detector 17. Camera 13 may be, for example, a digital camera or a video camera. Camera 13 may capture images of following vehicle 9 when signaled by video camera detector 17, which itself also may capture images of following vehicle 9. More specifically, camera 13 and video camera detector 17 may record identification information specific to following vehicle 9, such as a license plate number. The image data may be communicated from camera 13 and video camera detector 17 through communication network 14 such as a cellular phone network, LAN, WiFi, WiMax, satellite network, the Internet, or other appropriate communication network as understood by those of skill in the art. In the illustrated example, following vehicle 9 is a tailgating vehicle because it is following lead vehicle 7 too closely.

Those skilled in the art will recognize that other systems for detecting and recording tailgating violations are within the scope of the present invention. For example, transponders within vehicles, such as those commonly referred to as toll tags, could be used to calculate the distance or time between vehicles. A transponder also could transmit information identifying the vehicle carrying the transponder. In such a system, a camera may not be necessary. Nonetheless, a camera is preferred so that images captured by the camera may be used as evidence of the tailgating violation and so that violators who are cited may receive visual proof of the violation.

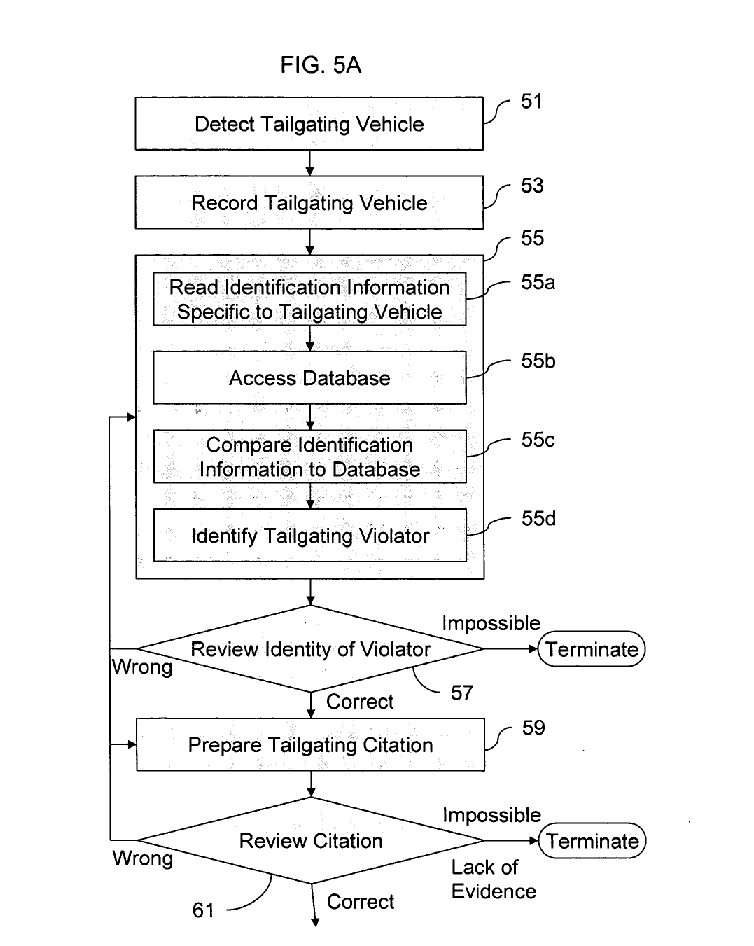

FIG. 4 is a flowchart of a method for issuing tailgating citations and scheduling court dates according to an embodiment of the present invention. Identification information specific to a tailgating vehicle may arrive at identification computer 19 from recorder 13 of FIGS. 1-3 via communication network 14. Thus identification computer 19 is in communication with recorder 13. Identification computer 19 also is in communication with vehicle and registrant identification information database 21. Vehicle and registrant identification database 21 is of the type commonly maintained by a state department of motor vehicles or state department of public safety and includes information such as the name and address of the registrant and owner of each vehicle in the database, the license plate number and vehicle identification number of each vehicle, and other information useful for law enforcement and fee collection purposes. Identification computer 19 is adapted to identify a tailgating violator by comparing identifying information specific to the tailgating vehicle to the vehicle and registrant identification information contained in the vehicle and registrant identification information database. More specifically, identification computer 19 may read identification information specific to the tailgating vehicle by using optical character recognition to read the license plate number of the tailgating vehicle or to read identification information from information provided by a transponder carried by the tailgating vehicle. Identification computer 19 also may access vehicle and registrant identification information database 21. Identification computer 19 may compare the identification information specific to the tailgating vehicle to vehicle and registrant information contained in vehicle and registrant identification information database 21. Identification computer 19 also may identify a tailgating violator by correlating the identification information specific to the tailgating vehicle to the registrant, or owner, of the tailgating vehicle. Those skilled in the art will recognize that identification computer 19 may comprise multiple computers or a single computer.

Identification computer 19 also is in communication with citation preparation computer 23. Citation preparation computer 23 is adapted to prepare tailgating citations incorporating, for example, the name and address of the registrant of the tailgating vehicle, the time and place of the tailgating violation, payment information such as amount and payment methods, and images of the tailgating vehicle and the tailgating violation. Those skilled in the art will recognize that citation preparation computer 23 may comprise multiple computers or a single computer. Identification computer 19 and/or citation preparation computer 23 optionally also may be in communication with review workstation 25. A human user 27, such a police officer, may review evidence collected by recorder 13, the identity of the tailgating violator determined by identification computer 19, and the information contained on the citation prepared by citation preparation computer 23 using review workstation 25. Such a review by a police officer may be required by law to ensure that a tailgating violation in fact occurred and that the correct violator has been identified. In the event that the police officer determines an error has occurred, the officer may send the information back to the point in the system where the problem occurred. Alternatively, the officer may correct the mistake manually. In the event that the officer determines that no tailgating violation occurred, the citation may be cancelled so that it does reach the registrant in error. The tailgating citation prepared by citation preparation computer 23 may be communicated to tailgating violator or registrant 31 via citation communication means 29, such as mail, courier, facsimile, email, or other appropriate means for communicating a citation to tailgating violator 31.

Payment computer 33 is adapted to determine whether proper payment has been received for the tailgating violation. If payment was made in accordance with the tailgating citation, the payment may be recorded. If no payment was made, or the payment was deficient in amount or late, payment computer 33 may signal scheduling computer 35 that proper payment has not been made. Scheduling computer 35 may access court schedule database 37 in order to identify an available court date. Scheduling computer 35 is in communication with both payment computer 33 and court schedule database 37. Scheduling computer 35 may schedule a court date on the available court date. Alternatively or additionally, scheduling computer 35 may be in communication with identification computer 19 or citation preparation computer 23, as well as court schedule database 37. In this embodiment, a court date may be scheduled approximately concurrently with the identification of tailgating violator 31 and the preparation of the tailgating citation. A summons preparation computer 39 in communication with scheduling computer 35 may prepare a summons containing, for example, the date, time, and location of the court date. The summons prepared by summons preparation computer 39 may be communicated to tailgating violator or registrant 31 via summons communication means 41, such as mail, courier, facsimile, process server, constable, email, or any other appropriate mean for communicating a summons to tailgating violator 31.

Those skilled in the art will recognize that identification computer 19, citation preparation computer 23, review workstation 25, scheduling computer 33, and summons preparation computer 39 may comprise a single computer or multiple computers. Furthermore, these computers may communicate with one another using standard networks such as Ethernet, WiFi, WiMax, LAN, WAN, the Internet, or others. In addition, vehicle and registrant identification information database 21 and court schedule database 37 may be maintained on separate computers operated by separate state agencies and in communication with the computers identified herein using standard networks such as Ethernet, WiFi, WiMax, LAN, WAN, the Internet, or others. Alternatively, vehicle and registrant identification information database 21 and court schedule database 37 may be maintained at some other appropriate location such as within one or more of identification computer 19, citation preparation computer 23, review workstation 25, scheduling computer 33, and summons preparation computer 39. For purposes of the preferred embodiment of the present invention, a vehicle owner may be considered equivalent to a vehicle registrant.

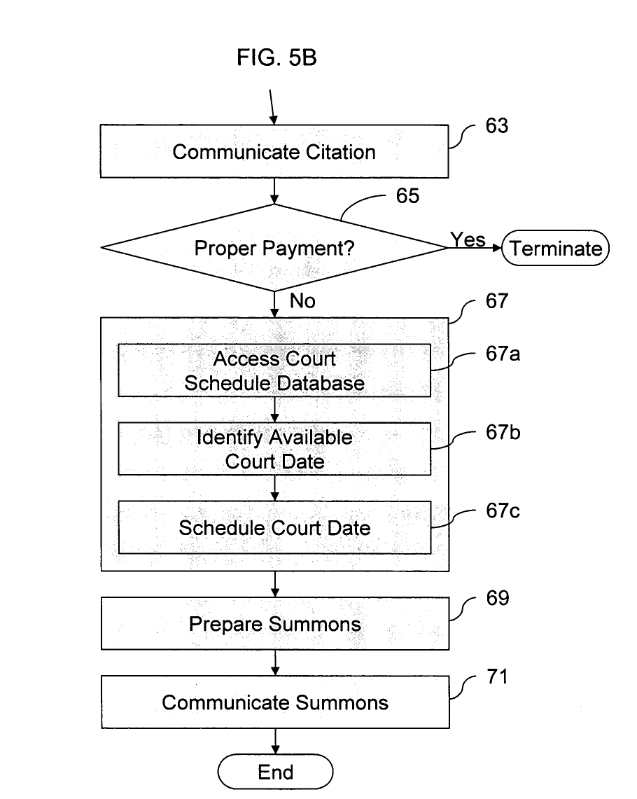

FIGS. 5A and 5B are a flowchart illustrating a method to detect and cite tailgating violations using an automated system in accordance with an embodiment of the present invention. Process box 51 comprises the step of detecting a tailgating vehicle with a tailgating detector of the automated system. Process box 53 comprises the step of recording the tailgating vehicle with a recorder of the automated system. Process box 55 comprises the step of identifying a tailgating violator with an identification computer of the automated system, the identification computer adapted to be in communication with the recorder and a vehicle and registrant identification information database of the automated system. Process box 55 comprises steps 55a-55d. Step 55a comprises the step of reading identification information specific to the tailgating vehicle with the identification computer. Step 55b comprises the step of accessing a vehicle and registrant identification information database with the identification computer. Step 55c comprises the step of comparing the identification information specific to the tailgating vehicle to the vehicle and registrant information contained in the vehicle and registrant identification information database with the identification computer. Step 55d comprises the step of identifying a tailgating violator by correlating the identification information specific to the tailgating vehicle to the registrant of the tailgating vehicle with the identification computer. Optional decision box 57 comprises the step of reviewing the identity of the tailgating violator identified in process box 55 by a human user. If the wrong violator, or registrant, was determined in process box 55, then step 55 may be repeated. If it is determined that no identification can be made or that no violation occurred, the process may be terminated. If it is determined that the correct identification was made, the process may continue to the next step. Process box 59 comprises the step of preparing a tailgating citation with a citation preparation computer of the automated system. Optional decision box 61 comprises the step of reviewing the citation prepared in step 59 for accuracy by a human user. If an inaccuracy is identified, then steps 55 and/or 59 may be repeated. If it is determined that no identification can be made or that no violation occurred, the citation may be cancelled and the process terminated. If it is determined that the identification was correct and that the citation is accurate, the process may continue to the next step. Process box 63 comprises the step of communicating the tailgating citation to the tailgating violator.

Decision box 65 comprises the step of determining whether proper payment has been received for the tailgating citation with a payment computer of the automated system. If proper payment has been received, the process may be terminated. If proper payment has not been received, the process may continue to the next step. Process box 67 comprises the step of scheduling a court date with a scheduling computer of the automated system in communication with a court schedule database of the automated system. Process box 67 comprises steps 67a-67c. Step 67a comprises the step of accessing a court schedule database with a scheduling computer in communication with the court schedule database. Step 67b comprises the step of identifying an available court date with the scheduling computer. Step 67c comprises the step of scheduling a court date on the available court date with the scheduling computer. Processes box 69 comprises the step of preparing a summons with a summons preparation computer of the automated system. Process box 71 comprises the step of communicating the summons to the tailgating violator.

Alternatively, steps 67-71 could be performed approximately concurrently with steps 55-63. In this alternative embodiment, the summons and tailgating citation may be communicated to the tailgating violator at the same time. Also in this alternative embodiment, the step of determining whether proper payment has been received for the tailgating citation could be the final step in the process. If payment was made, the court date may be cancelled. If no payment was made, the court date may stand.

Those skilled in the art will recognize that the identification computer, citation preparation computer, scheduling computer, and summons preparation computer may comprise a single computer or multiple computers. Furthermore, these computers may communicate with one another using standard networks such as Ethernet, WiFi, WiMax, LAN, WAN, the Internet, or others. In addition, the vehicle and registrant identification information database and court schedule database may be maintained on separate computers operated by separate state agencies and in communication with the computers identified herein using standard networks such as Ethernet, WiFi, WiMax, LAN, WAN, the Internet, or others. Alternatively, the vehicle and registrant identification information database and court schedule database may be maintained at some other appropriate location such as within one or more of the identification computer, citation preparation computer, scheduling computer, and summons preparation computer. For purposes of the preferred embodiment of the present invention, a vehicle owner may be considered equivalent to a vehicle registrant.

In the drawings and specification, there have been disclosed embodiments of the invention and, although specific terms are employed, they are used in a generic and descriptive sense only and not for the purpose of limitation, the scope of the invention being set forth in the following claims.

What claimed is:

1. A method to detect and cite tailgating violations using an automated system comprising the steps of:
(a) detecting a tailgating vehicle with a tailgating detector of the automated system;
(b) recording the tailgating vehicle with a recorder of the automated system;
(c) identifying a tailgating violator with an identification computer of the automated system, the identification computer adapted to be in communication with the recorder and a vehicle and registrant identification information database of the automated system;
(d) preparing a tailgating citation with a citation preparation computer of the automated system; and
(e) communicating the tailgating citation to the tailgating violator.

2. The method of claim 1 further comprising the step of:
(f) determining whether proper payment has been received for the tailgating citation with a payment computer of the automated system; and, if not,
scheduling a court date with a scheduling computer of the automated system in communication with a court schedule database of the automated system;
preparing a summons with a summons preparation computer of the automated system; and
communicating the summons to the tailgating violator.

3. The method of claim 1 wherein step (c) comprises the steps of:
reading identification information specific to the tailgating vehicle with the identification computer;
accessing the vehicle and registrant identification information database with the identification computer;
comparing the identification information specific to the tailgating vehicle to vehicle and registrant identification information contained in the vehicle and registrant identification information database with the identification computer; and
identifying the tailgating violator by correlating the identification information specific to the tailgating vehicle to the registrant of the tailgating vehicle with the identification computer.

4. The method of claim 3 wherein the identification information specific to the tailgating vehicle comprises a license plate number.

5. The method of claim 2 wherein the court date is scheduled by:
accessing the court schedule database with the scheduling computer;
identifying an available court date with the scheduling computer; and
scheduling the court date on the available court date with the scheduling computer.

6. The method of claim 1 further comprising the step of
(g) reviewing one or more of the other steps of the method by a human user.

7. A method to detect and cite tailgating violations using an automated system comprising the steps of:
(a) detecting a tailgating vehicle with a tailgating detector of the automated system;
(b) recording the tailgating vehicle with a recorder of the automated system;
(c) reading identification information specific to the tailgating vehicle with an identification computer of the automated system;
(d) accessing a vehicle and registrant identification information database of the automated system with the identification computer;
(e) comparing the identification information specific to the tailgating vehicle to vehicle and registrant information contained in the vehicle and registrant identification information database with the identification computer;
(f) identifying a tailgating violator by correlating the identification information specific to the tailgating vehicle to the registrant of the tailgating vehicle with the identification computer;
(g) accessing a court schedule database of the automated system with a scheduling computer of the automated system in communication with the court schedule database;
(h) identifying an available court date with the scheduling computer;
(i) scheduling a court date on the available court date with the scheduling computer;
(j) preparing a summons with a summons preparation computer of the automated system;
(k) preparing a tailgating citation with a citation preparation computer of the automated system; and
(l) communicating the summons and the tailgating citation to the tailgating violator.

8. A system to detect and cite tailgating violations comprising:
a tailgating detector adapted to detect a tailgating vehicle;
a recorder in communication with the tailgating detector and adapted to record identification information specific to the tailgating vehicle;
an identification computer in communication with the recorder and a vehicle and registrant identification information database, the identification computer adapted to identify a tailgating violator by comparing the identification information specific to the tailgating vehicle to vehicle and registrant identification information contained in the vehicle and registrant identification information database;
a citation preparation computer in communication with the identification computer, the citation preparation computer adapted to prepare a tailgating citation; and
a citation communication means for communicating the tailgating citation to the tailgating violator.

9. The system of claim 8 further comprising:
a scheduling computer in communication with a court schedule database, the scheduling computer adapted to identify an available court date;
a summons preparation computer in communication with the scheduling computer, the summons preparation computer adapted to prepare a summons; and
a summons communication means for communicating the summons to the tailgating violator.

10. They system of claim 9 further comprising:
a payment computer in communication with the scheduling computer, the payment computer adapted to determine whether proper payment has been received for the tailgating citation.

11. The system of claim 8 wherein the tailgating detector comprises an inductance coil.

12. The system of claim 8 wherein the tailgating detector comprises a radiant beam.

13. The system of claim 8 wherein the tailgating detector comprises a video camera.

14. The system of claim 8 wherein the recorder comprises a digital camera.

15. The system of claim 8 wherein the recorder comprises a video camera.

16. The system of claim 8 further comprising:
a review workstation adapted to facilitate review of the identity of the tailgating violator by a human user.

17. The system of claim 8 further comprising:
a review workstation adapted to facilitate review of the tailgating citation by a human user.
